(19) United States
(12) Patent Application Publication
(10) Pub. No.: US 2021/0090035 A1
(43) Pub. Date: Mar. 25, 2021

(54) SYSTEM AND METHOD FOR TRANSMITTING DATA OVER AUTHORIZED TRANSMISSION CHANNELS

(71) Applicant: SHOPIFY INC., Ottawa (CA)

(72) Inventors: KYLE BRUCE TATE, OTTAWA (CA); SAAD ATIEQUE, TORONTO (CA)

(21) Appl. No.: 16/580,008

(22) Filed: Sep. 24, 2019

(51) Int. Cl. G06Q 20/02; G06Q 30/06

(52) U.S. Cl. CPC G06Q 20/027; G06Q 30/0641

(57) ABSTRACT

Systems and methods of transmitting data over authorized transmission channels are provided. Data for transmission is segregated into subsets such that the subsets may be processed by multiple authorized transmission channels, thus providing flexibility in that data subsets may have differing characteristics that would allow transmission over different authorized transmission channels. The data transmission systems and methods may be implemented in an e-commerce environment to process transaction data via payment gateways.

### FIELD

The following application relates to systems and methods of transmitting data over authorized transmission channels.

### BACKGROUND

It is common in existing data transmission systems to transmit the entirety of a set of data over a single authorized transmission channel. For example, at checkout in an e-commerce platform, it is common for all the checkout data to be transmitted to a single authorized payment gateway.

In an e-commerce environment, a buyer may want to commit to a purchase of goods or services. However, a monetary transaction is limited to online means as the merchant has no convenient way of collecting physical money or reading the chip of a credit or debit card.

In most e-commerce environments, a credit card and its corresponding identification number are used to complete the purchase. Certain debit cards may also be used. The merchant must provide a secure means of processing the transaction and connecting to payment processors and connecting the various banking and credit card accounts involved. However, it is challenging for a merchant to provide such services as they are complex and expensive to run, especially for smaller businesses.

External (i.e. 3^{rd} party) payment gateways are used to fulfill transactions, process payments, and provide fraud checking on behalf of the merchant for a fee and/or a percentage cut of the transaction. Such gateways may be provided by an e-commerce platform or an external payment gateway provider. An example of a method performed by a payment gateway is provided in the detailed description.

However, due to the nature of payment gateways, risk profiles and the credit card companies that their services support, the sales of certain products may not be supported by a given payment gateway due to inherent or perceived risk to the gateway or credit card company. As such, merchants who wish to sell such items, or wish to add such products to an existing catalogue, may need to switch their entire business to a different payment gateway provider, typically one with higher transaction fees. This presents significant cost and inconvenience to the merchant.

### SUMMARY

Systems and methods are provided which allow multiple authorized transmission channels to be used to transmit respective subsets of a data set that for transmission. This provides flexibility in that where the subsets of data may have different characteristics that would allow transmission over different authorized transmission channels, this can be done rather than requiring all the data be sent over a single authorized transmission channel.

Systems and methods are provided which allow a merchant to use multiple payment gateways that are selected for a buyer on a per order basis or on a per product basis. The systems and methods may utilize a combination of buyer information, merchant information, and product information to select the payment gateways for an order or a selection of products in an order.

According to one aspect of the present invention, there is provided an automated data transmission method comprising: receiving a set of data for a data transmission; segregating the set of data into at least two subsets of data according to which one of a plurality of available transmission channels is authorized to be used for each subset; transmitting each subset of data over the one of the plurality of transmission channels authorized to be used for the subset.

In some embodiments, receiving a set of data comprises receiving customer input selecting at least two products for purchase; segregating the set of data into at least two subsets comprises making a payment gateway decision by selecting at least two payment gateways from a plurality of available payment gateways to process the purchase of the at least two products, the payment gateway decision being made at least in part on the at least two products selected for purchase, such that each subset of data is associated with a respective selected payment gateway; transmitting each subset of data over the one of the plurality of transmission channels authorized to be used for the subset comprises transmitting the subset to the respective payment gateway.

In some embodiments, transmitting checkout information to the selected at least one of the plurality of available payment gateways comprises: for each of the available payment gateways, transmitting data on the products for which the available payment gateway was selected;

In some embodiments, receiving customer input selecting at least two products for purchase comprises receiving customer input selecting a plurality of products; making the payment gateway decision comprises selecting a single payment gateway based on the plurality of products collectively.

In some embodiments, the method further comprises: configuring a checkout user interface to display the payment gateway decision to the customer.

In some embodiments, making the payment gateway decision is based on a risk associated with a given product.

In some embodiments, making the payment gateway decision is also based on customer information.

In some embodiments, making the payment gateway decision is based on the respective associated costs of use of the two or more available payment gateways.

In some embodiments, receiving configuration inputs to configure how the payment gateway decision is made.

In some embodiments, the method further comprises: providing a checkout user interface for receiving said customer input as a web page.

In some embodiments, the method further comprises: making the payment gateway decision is based on one or more configured preferences, said preferences being assigned as a product specific preference or as a default preference or a combination thereof.

In some embodiments, receiving a set of data comprises receiving customer input selecting at least two products for purchase; and segregating the set of data into at least two subsets comprises segregating data into at least two subsets based on payment recipient, each subset including data in respect of payment to a respective payment recipient; the method further comprising for each payment recipient, determining a respective payment gateway; wherein transmitting each subset of data over the one of the plurality of transmission channels authorized to be used for the subset comprises transmitting the subset to the respective payment gateway.

In some embodiments, receiving a set of data comprises receiving customer input selecting at least two products for purchase; and segregating the set of data into at least two subsets comprises segregating data into a subset associated with a pre-tax amount and a subset associated with a tax amount; the method further comprising determining a respective payment gateway for the subset associated with the pre-tax amount and for the subset associated with the tax amount; wherein transmitting each subset of data over the one of the plurality of transmission channels authorized to be used for the subset comprises transmitting the subset to the respective payment gateway.

In some embodiments, receiving a set of data comprises receiving customer input selecting at least two products for purchase; and segregating the set of data into at least two subsets comprises segregating data into a subset associated a payment to a digital media provider and a subset associated with a payment amount to a digital media creator; the method further comprising determining a respective payment gateway for the subset associated with payment to the digital media provider and for the subset associated with the payment to the digital media creator; wherein transmitting each subset of data over the one of the plurality of transmission channels authorized to be used for the subset comprises transmitting the subset to the respective payment gateway.

In some embodiments, receiving a set of data comprises receiving customer input selecting at least two products for purchase; and segregating the set of data into at least two subsets comprises segregating data into a a subset associated with a purchase amount and a subset associated with a charity amount; the method further comprising determining a respective payment gateway for the subset associated with the purchase amount and for the subset associated with the charity amount; wherein transmitting each subset of data over the one of the plurality of transmission channels authorized to be used for the subset comprises transmitting the subset to the respective payment gateway.

In some embodiments, the method further comprises: aggregating data for multiple purchases before performing payment capture.

According to another aspect of the present invention, there is provided an automated data transmission apparatus comprising: an interface for receiving a set of data for a data transmission; a data segregator configured to segregating the set of data into at least two subsets of data according to which one of a plurality of available transmission channels is authorized to be used for each subset; a transmitter configured to transmit each subset of data over the one of the plurality of transmission channels authorized to be used for the subset.

In some embodiments, the interface for receiving a set of data comprises an interface for receiving customer input selecting at least two products for purchase; the data segregator comprises a product specific payment gateway selector configured to make a payment gateway decision by selecting at least one payment gateway from a plurality of available payment gateways to process the purchase of the at least two products, the payment gateway decision being made at least in part on the at least two products selected for purchase, such that each subset of data is associated with a respective selected payment gateway; the transmitter is configured to transmit each subset of data over the one of the plurality of transmission channels authorized to be used for the subset by sending the subset to the respective payment gateway.

In some embodiments, the product specific payment gateway selector is configured to transmit checkout information to the selected at least one of the plurality of available payment gateways by: for each of the available payment gateways, transmitting data on the products for which the available payment gateway was selected.

In some embodiments, the apparatus wherein the product specific payment gateway is configured to: when the at least two products comprises a plurality of products, select a single payment gateway based on the plurality of products collectively.

In some embodiments, the apparatus is further configured to configure a checkout user interface to display the payment gateway decision to the customer.

In some embodiments, wherein the product specific payment gateway selector makes the payment gateway decision based on a risk associated with a given product.

In some embodiments, the product specific payment gateway selector makes the payment gateway decision based on customer information.

In some embodiments, the product specific payment gateway selector makes the payment gateway decision based on the respective associated costs of use of the two or more available payment gateways.

In some embodiments, the apparatus further comprises: a configuration interface for receiving configuration inputs to configure how the payment gateway decision is made.

In some embodiments, the product specific gateway selector makes the payment gateway decision based on one or more configured preferences, said preferences being assigned as a product specific preference or as a default preference or a combination thereof.

According to another aspect of the present invention, there is provided an e-commerce platform comprising the apparatus described above.

### BRIEF DESCRIPTION OF THE DRAWINGS

Embodiments of disclosure will now be described with reference to the attached drawings in which:

FIG. 1A is a flowchart of an automated data transmission apparatus provided by an embodiment of the invention;

FIG. 1B is a block diagram of an automated data transmission apparatus provided by an embodiment of the invention;

FIG. 2A is a block diagram of an e-commerce platform, according to one embodiment;

FIG. 2B is an example of a home page of a merchant, according to one embodiment;

FIG. 3 is a system for selecting payment gateways for a transaction, according to one embodiment;

FIG. 4 is a system for selecting payment gateways for a transaction, according to another embodiment;

FIGS. 5 and 6 illustrate graphical user interfaces that a buyer may use to complete a transaction, according to one embodiment;

FIG. 7 illustrates a graphical user interface for a merchant to configure installment payments, according to one embodiment;

FIG. 8 illustrates a method performed by the system to complete a transaction with multiple payment gateways, according to a product specific implementation;

FIG. 9 illustrates a method performed by the system to complete a transaction with a selected payment gateway, according to a shopping cart specific implementation;

FIG. 10 is a flowchart of a method where data is segregated based on payment recipient;

FIG. 11 is a flowchart of a method where data is segregated based as between a pre-tax amount and a tax amount;

FIG. 12 is a flowchart of a method where data is segregated based as between a digital media provider and a digital media creator;

FIG. 13 is a flowchart of a method where data is segregated based as between a purchase amount and a charity amount; and

FIG. 14 is a flowchart of a method where data aggregation is performed.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

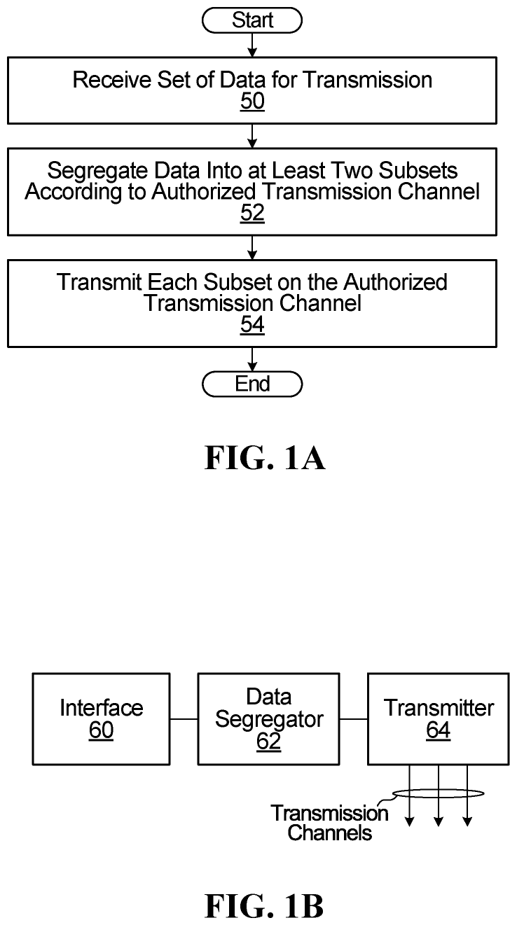

Referring to FIG. 1A, shown is a flowchart of an automated data transmission method provided by an embodiment of the invention. The method begins in block 50 with receiving a set of data for a data transmission. The method continues in block 52 with segregating the set of data into at least two subsets of data according to which one of a plurality of available transmission channels is authorized to be used for each subset. In some embodiments, this segregation is based on the actual content of the data. The method continues in block 54 with transmitting each subset of data over the one of the plurality of transmission channels authorized to be used for the subset.

In some embodiments, receiving a set of data involves receiving customer input selecting at least two products for purchase. Detailed examples of receiving such customer input are provided below.

In some embodiments, segregating the set of data into at least two subsets comprises making a payment gateway decision by selecting at least two payment gateways from a plurality of available payment gateways to process the purchase of the at least two products, the payment gateway decision being made at least in part on the at least two products selected for purchase, such that each subset of data is associated with a respective selected payment gateway. Detailed examples of such data segregation are provided below. As noted above, in some embodiments, this segregation is based on the actual content of the data. Where the data pertains to selection of products to purchase, the segregation is based on the data identifying the actual products, such that for certain products, one payment gateway is selected, whereas for other products, a different payment gateway is selected. The remainder of this description is focused on the embodiment in which the set of data is customer input selecting at least two products for purchase. However, the more general embodiment of FIGS. 1A and 1B is not limited to this case.

In some embodiments, transmitting each subset of data over the one of the plurality of transmission channels authorized to be used for the subset comprises transmitting the subset to the respective payment gateway. Detailed examples of the use of multiple payment gateways are provided below.

Referring now to FIG. 1B, shown is a block diagram of an automated data transmission apparatus provided by an embodiment of the invention. The apparatus has an interface 60 for receiving a set of data for a data transmission. The apparatus has a data segregator 62 configured to segregating the set of data into at least two subsets of data according to which one of a plurality of available transmission channels is authorized to be used for each subset. As in the method of FIG. 1A, the data segregator may segregate the data based on the actual content of the data, which determines which transmission channel can be used to transmit the data. The apparatus includes a transmitter 64 configured to transmit each subset of data over the one of the plurality of transmission channels authorized to be used for the subset.

The interface 60 may, for example, be in the form of a web page sent or downloaded to a user device such as a mobile device or other computing device. Detailed examples of an interface for receiving data are provided below. In some embodiments, the interface for receiving a set of data comprises an interface for receiving customer input selecting at least two products for purchase. This may, for example, be in the form of a checkout page provided through an e-commerce platform. Detailed examples of possible implementations of the interface 60 are provided below.

In some embodiments, the data segregator 62 comprises a product specific payment gateway selector configured to make a payment gateway decision by selecting at least one payment gateway from a plurality of available payment gateways to process the purchase of the at least two products, the payment gateway decision being made at least in part on the at least two products selected for purchase, such that each subset of data is associated with a respective selected payment gateway. Detailed examples of how this data segregation may be performed are provided below. Any of these approaches may be implemented by the data segregator 62.

In some embodiments, the transmitter 64 is configured to transmit each subset of data over the one of the plurality of transmission channels authorized to be used for the subset by sending the subset to a respective payment gateway. In this manner, data in respect of multiple purchases being made through the interface 60 is sent to multiple different payment gateways.

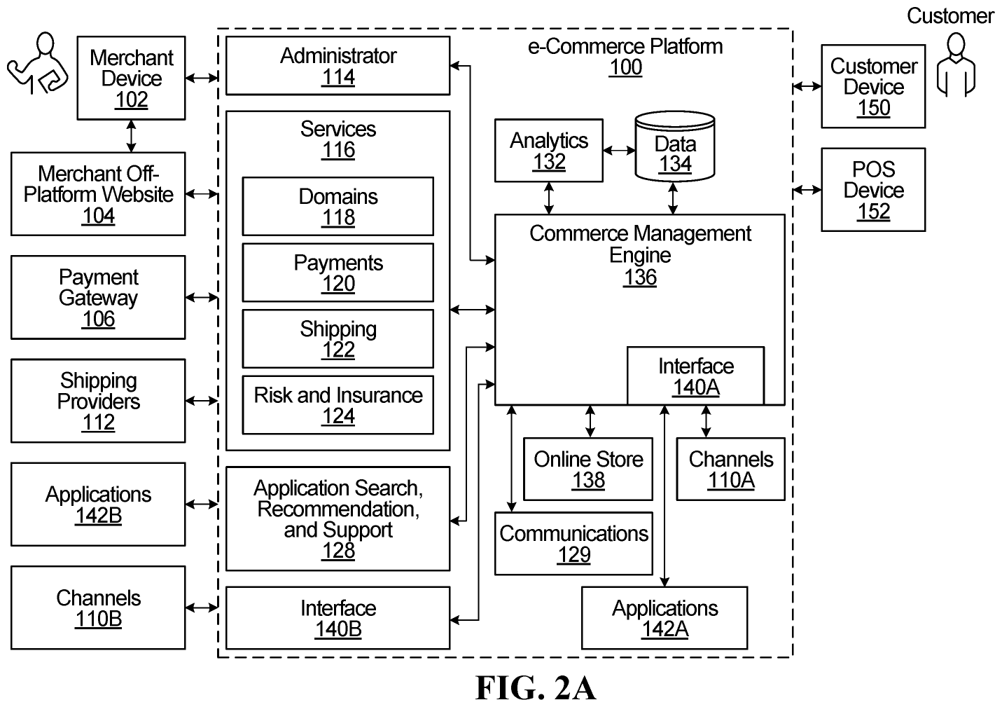

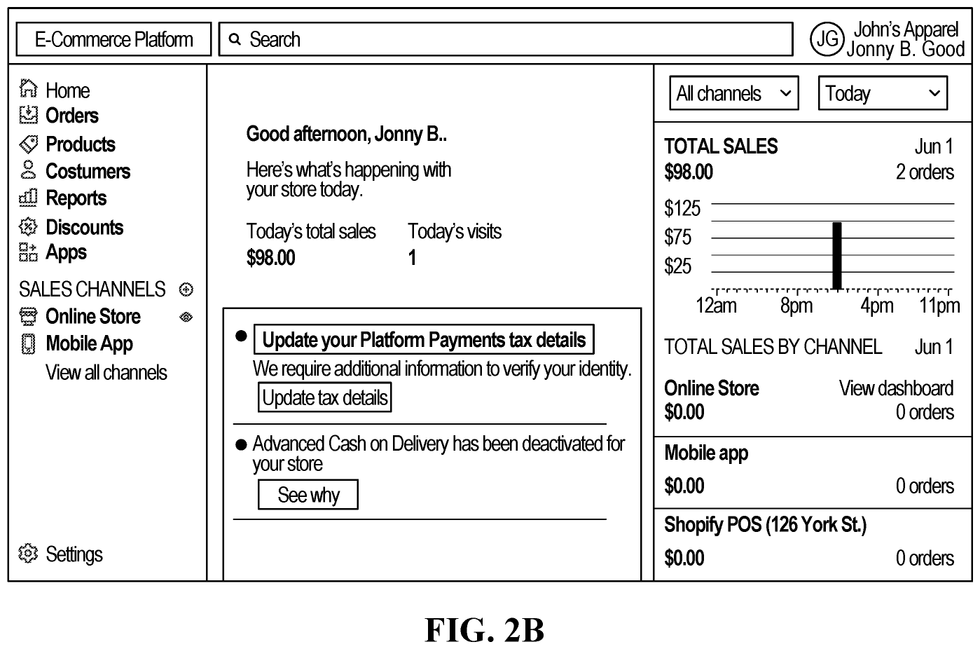

With reference to FIG. 2A, an embodiment e-commerce platform 100 is depicted for providing merchant products and services to customers. While the disclosure throughout contemplates using the apparatus, system, and process disclosed to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

FIG. 2B depicts a non-limiting embodiment for a home page of an administrator 114, which may show information about daily tasks, a store's recent activity, and the next steps a merchant can take to build their business. In embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In embodiments, the merchant may be able to access the different sections of administrator 114 by using the sidebar, such as shown on FIG. 2B. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 2A, in embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In embodiments, an application 142A may be provided by the same party providing the platform 100 or by a different party. In embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In embodiments, rather than violating the isolation principle, it may be preferred to move these components out of the commerce management engine 136 and into their own infrastructure within the e-commerce platform 100.

In embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In embodiments, core products, core extension points, applications, and the administrator 114 may be developed to work together. For instance, application extension points may be built inside the administrator 114 so that core features may be extended by way of applications, which may deliver functionality to a merchant through the extension.

In embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In embodiments, partners, application developers, internal applications facilities, and the like, may be provided with a software development kit (SDK), such as through creating a frame within the administrator 114 that sandboxes an application interface. In embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In embodiments, update events may be queued and processed asynchronously from a state change that triggered them, which may produce an update event notification that is not distributed in real-time.

In embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In embodiments, the payment gateway 106 may accept international payment, such as integrating with leading international credit card processors. The card server environment may include a card server application, card sink, hosted fields, and the like. This environment may act as the secure gatekeeper of the sensitive credit card information. In embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In embodiments, the e-commerce platform 100 may enable merchants to keep track of changes to the contract of sales over time, such as implemented through a sales model component (e.g., an append-only date-based ledger that records sale-related events that happened to an item).

The e-commerce platform 100 may be providing sales channels for multiple merchants, for their respective customers, and for varying types of merchandise. Payment gateways 106 are provided by the e-commerce platform or by external parties to process transactions in an e-commerce environment.

The E-commerce platform of FIG. 2A can be used to implement embodiments of the invention, by including the components of FIG. 1B. For example, the interface 60 of FIG. 1 for receiving purchasing data from customers may be provided by the commerce management engine 136 as an online store 138 that is accessed as a web page on a customer device 150.

The data segregator 62 may be implemented as part of the commerce management engine 136, or as a separate component that is connected to the commerce management engine 136. The E-commerce platform 100 is connected to multiple payment gateways 106 (only one shown). The payments service 120 may function as a transmitter 64 to transmit data to selected payment gateways.

Method for Payment Processing with a Payment Gateway

The following is an example of a method by which a payment gateway may process a payment or transaction. This disclosure is not limited to this specific method.

At the checkout page, the customer must input their credit card information, including the card number, the security code, and the expiration date. Additional information may be gathered, such as the customer's name, billing address, or some other verification. The payment process is initiated when a customer confirms their order by pressing a “Submit” or “Checkout” button. Alternatively, for some services, the customer may need to fill out more information on a page used by the payment gateway (e.g. PayPal Payment Standard™, Authorize.net™, or Stripe™). The data entered on the checkout page is compiled and typically is encrypted by the payment gateway to protect sensitive personal and credit card information. For example, SSL (Secure Socket Layering) encryption may be used.

The payment gateway may also perform initial fraud checks; it may also gather other information which may be used to confirm identity and prevent fraud later. For example, purchase history, device fingerprinting, geolocation, and site usage data may be collected. Other fraud prevention techniques such as blacklist-checking, email verification, and risk scoring may be used as a part of the subsequent processes.

The transaction information may be translated by the payment gateway into one readable by a payment processor, such as transferring XML to ISO 8583.

The payment gateway sends of the pertinent information to a payment processor (also often referred to as the “acquiring bank”). The payment processor may confirm that the transaction is secure or continue with fraud checks. The payment processor has access to the merchant's bank account and is used to request that the cardholder pay the merchant the sum laid out in the transaction confirmation. This request is interpreted by the payment processor and forwarded to a credit card network (if a credit card was used). The credit card network can access data on all issued credit cards, and uses the transaction data (i.e. the card number) to find the credit card used in the transaction and locate the related issuing bank.

In some cases the credit card company issues its own credit cards, and so in effect the credit card company functions as an issuing bank. This is the case, for example, for American Express. However, in most circumstances, the credit card will be issued by a specific consumer/retail bank. In this case, the specific consume/retail bank is the issuing bank, and the credit card is tied to a specific account with the issuing bank. This is the case, for example, with VISA and Mastercard. If the issuing bank is the credit card company, the card information is internally verified. Fraud checks may be performed, which may include the use of the security code, billing address, personal information, device information, customer usage data and purchase history, etc. If the issuing bank is not the credit card company, the credit card network will request confirmation from the issuing bank. The issuing bank confirms that the card is connected to a valid account with a balance or credit limit that will accept the purchase. Similar fraud checks may be performed at this point, and may additionally include using information that the customer has provided the bank to confirm the authenticity of the purchase.

The issuing bank, whether it be the credit card company or an external bank, then sends a response through the credit card network accepting or declining the transaction. If a transaction is accepted, funds may be put on hold in the cardholders account. If the transaction is declined, a message may be added to the response detailing why it failed (e.g. insufficient funds, suspected fraud, account not found). The payment gateway receives the response from the bank and makes a final determination of whether the transaction is authorized. The purchase confirmation or failure is provided to the customer. The merchant may also receive confirmation from the payment gateway.

During this process a purchase is authorized, and will appear in a customer's credit records and a merchant's orders. However, funds have not yet been paid. When the merchant confirms the order and fulfills it (e.g. ships the items) a very similar process is repeated, only this time the message is changed from “authorized” to “cleared” and now funds may be transferred.

Fulfillment of payments may be done as follows. First, the payment processor (acquiring bank) sends a request to the credit card company to settle the funds. The credit card company confirms that the request for settlement is genuine, and then transfers the funds to the payment processor. The payment processor deposits said funds into the merchant's account.

If the credit card company is the issuing bank, the process ends here. If the credit card company is not the issuing bank, the credit card company sends a settlement request to the issuing bank to compensate the credit card company for the transferred funds. This request may be sent immediately following the paid out funds or after a designated period of time (e.g. monthly statements). The issuing bank receives and confirms the request. The issuing bank then removes the funds from the cardholder's account and reimburses the credit card company.

A payment gateway has an associated cost to the merchant, and different payment gateways may have different associated costs. In some existing applications, one or more payment gateways may be offered at checkout, and the merchant has the choice of which payment gateway to choose. For example, there may be one or more of “Paypal Payment Standard™” payment gateway, a “Authorize.net™” payment gateway, another credit card payment gateway. However, in some instances, the actual payment gateway employed at checkout is not apparent to the customer.

In addition, some payment gateways have limitations on the products they allow to be purchased using their services. In existing systems, where a merchant is initially using a payment gateway A, and then begins carrying merchandise that is not supported for payment gateway A, the merchant's entire business is switched over to a different payment gateway. This can result in increased costs to the merchant, since the different payment gateway will in most cases have higher fee to justify supporting a wider variety of items or products with a higher associated risk, even when purchases are being made of products that are not banned by the less expensive payment gateway.

### Product Specific Payment Gateway Selection

In some embodiments, a per-product payment gateway selector is provided which selects a product specific payment gateway on a per-product basis at checkout. This can result in the selection of multiple payment gateways, each to be used for one or more of the products in the shopping cart. In this case, the actual cost to the merchant is a blended cost that reflects a weighted average of the costs for the selected payment gateways. In some embodiments, the blended cost is calculated and provided to the merchant.

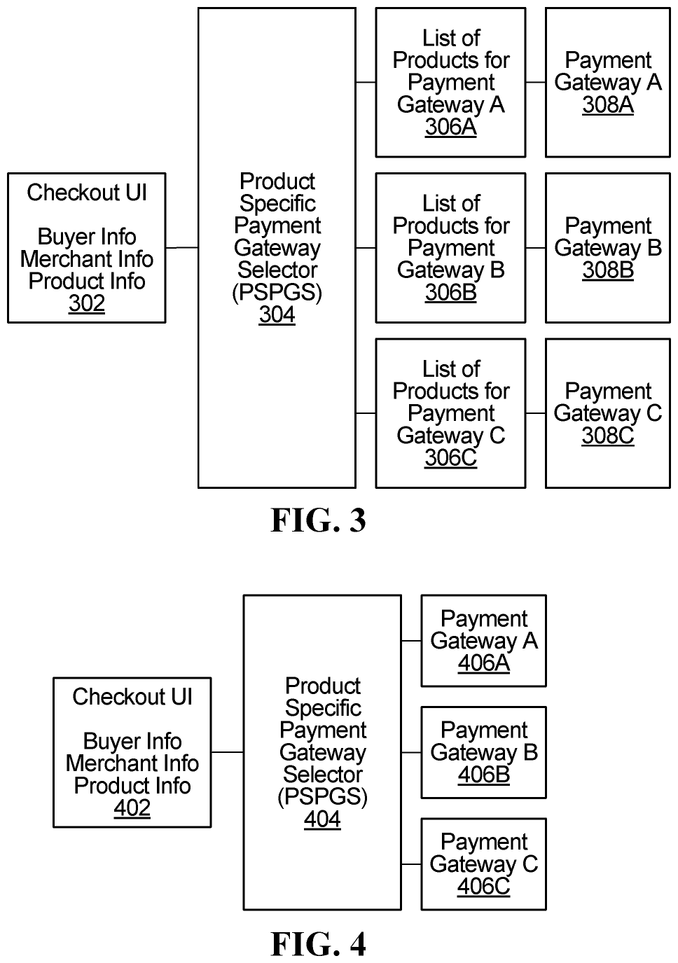

FIG. 3 illustrates a system that may be utilized to select multiple checkout gateways based on the products ordered. The system includes a checkout user interface (UI) 302 that is used to generate/collect checkout information when a customer tries to check out. The checkout UI 302 interacts with a product specific payment gateway selector (PSPGS) 304 which is responsible for selecting one or more payment gateways 308A, 308B, 308C based on the checkout information. The PSPGS 304 produces list of products 306A, 306B, 306C (from the shopping cart) that are to be processed by each payment gateway 308A, 308B, 308C. The number of payment gateways is a specific example. Any number, greater than two, may be employed.

The checkout information obtained through the checkout UI 302 contains one or more of combination of buyer information, merchant information, and product information. While depicted as coming from the checkout UI in the example of FIG. 2, more generally, this information may also be gathered from anywhere on a merchant's site or from a database (not shown) and may consist of files in a variety of formats.

The buyer information may include personal information, contact information, credit or debit card information, and/or personal credit information. The product information identifies the products, in the cart at checkout, that the buyer is attempting to purchase. The merchant information may include the list of payment gateways that are currently available or in use by the merchant and their associated costs; it may also include one or more default payment gateways that a merchant prefers to use.

The PSPGS 304 processes the checkout data to select payment gateway(s), as among those configured for the specific merchant, to process the transaction. The product specific payment gateway selector 304 may be implemented as a program or algorithm operated on a computing device.

The selection of the payment gateway for a given product can be made based on one or a combination of:
a. Specific defined rules that require specific products to be processed through specific gateways;
b. A risk associated with a given product

For example, all three of payment gateways A-C 308 A-C may be able to process a checkout item A, but the merchant configured the product A to be processed with payment gateway A. Alternatively, the item may not have a specific preference associated with it, but it is added to the list of products for payment gateway A 306A because payment gateway A 308A has been configured as the default.

As another example, a product B may have a high associated risk, such that payment gateways A-B 308A-B refuse to process the item, but payment gateway C will process the item. The product specific payment gateway selector 304 will automatically add the product B to the list of products for payment gateway C 306C in order to complete the purchase, regardless of the defaults set.

If none of the payment gateways A-C 308A-C is able to process one or more of the products in the order, the individual product may be rejected from the buyer's cart. The price of the item, along with any applicable incurred costs (i.e. taxes, shipping and handling) is subtracted from the order and the buyer is notified that the item cannot be processed. In another implementation, products that cannot be processed by any of the configured payment gateways A-C 306A-C are not visible to the buyer and cannot be added to a cart or order. Alternatively, the merchant must confirm that a product is supported by at least one of the payment gateways A-C 306A-C as a part of the process of adding the product to their catalogue.

In some embodiments, the payment gateway selection is also based on buyer information, such as creditworthiness of the buyer.

### Shopping Cart Specific Payment Gateway Selection

In some embodiments, a shopping cart specific payment gateway selector is provided which selects a single payment gateway at checkout that depends on the contents of the shopping cart, and possibly other factors such as buyer and merchant information. In this case, the cost to the merchant is that associated with the specific payment gateway chosen to fulfill the order.

FIG. 4 illustrates a system for a shopping cart specific implementation of payment gateway selection system. In many respects FIG. 4 is similar to FIG. 3, and includes a checkout UI 402, PSPGS 404 with access to multiple payment gateways 406A, 406B, 406C. The PSPGS 404 differs from PSPGS 304 in that rather than mapping products to payment gateways, PSPGS 404 selects a single payment gateway, as among those available for the specific merchant, and the entire shopping cart is processed as a single transaction through the selected payment gateway.

Methods similar to those described above can be used to select the payment gateway, with a conflict/priority mechanism for selecting a single payment gateway where the products would otherwise map to multiple different payment gateways.

### Customer Checkout Interface

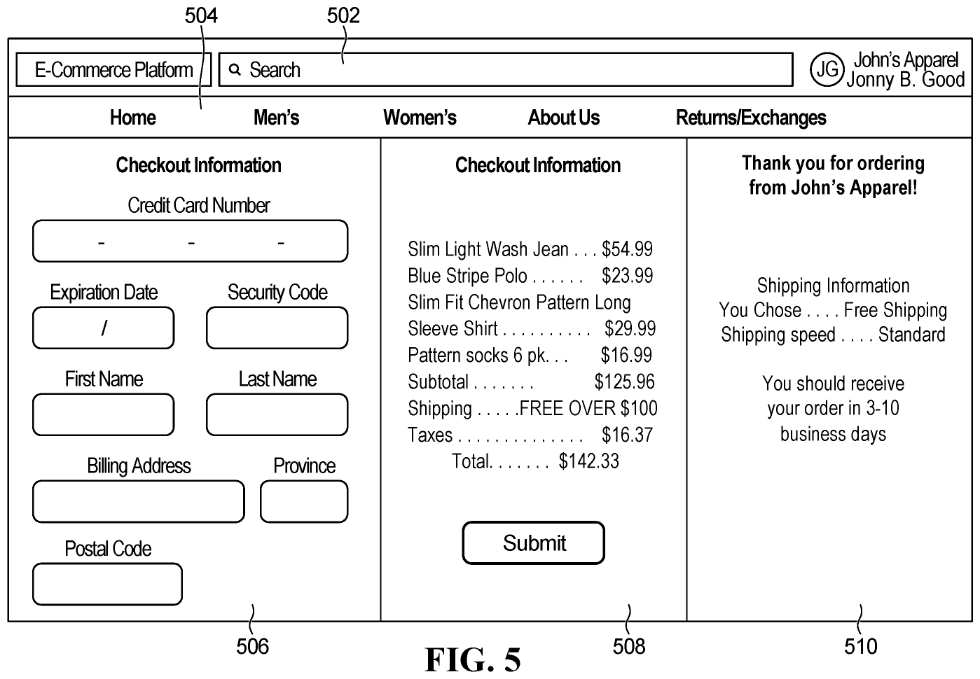

FIG. 5 illustrates an example of graphical user interface (henceforth referred to as a GUI) that may be used as a customer checkout interface, according to one implementation. The embodiment of FIG. 5 is suitable for use with approach described above, with reference to FIG. 4, in which the shopping cart is processed with multiple transactions through multiple payment gateways. The interface may include a search bar 502 which is capable of using keywords to locate information on the online store, app, or other interface which may include products, shipping information, or other information regarding the merchant or products offered. A selection of site headers 504 may be implemented for convenient navigation of the site.

A checkout information interface 506 is included as part of the customer checkout interface. The checkout information may include drop-down menus, empty fields, and/or selection boxes. Information requested may include credit card information (or debit card information where such a card has been authorized). The credit card information includes at least the credit card number and may include the security code and/or the expiration date as well. Customer personal information may also be collected, and may entail any or all of the customer's first and last name, billing address, postal code, email address, and phone number.

According to one embodiment, the GUI includes an order summary bar 508, which lists the items to be purchased as well as their prices. Other sums, additions, or subtractions to the price may also be listed, such as subtotals, totals, taxes, shipping costs, and discounts. It also includes a submit button which a consumer may click to submit the transaction information and complete the purchase In addition, The GUI includes a shipping confirmation bar, which may list shipping information, shipping carrier, and expected date or range of dates of arrival. Additionally, this interface includes a payment gateway information panel 510, which lists for the customer which product payments are to be routed through which payment gateways. This implementation includes this data as a way of promoting transparency and trust between a merchant and a customer.

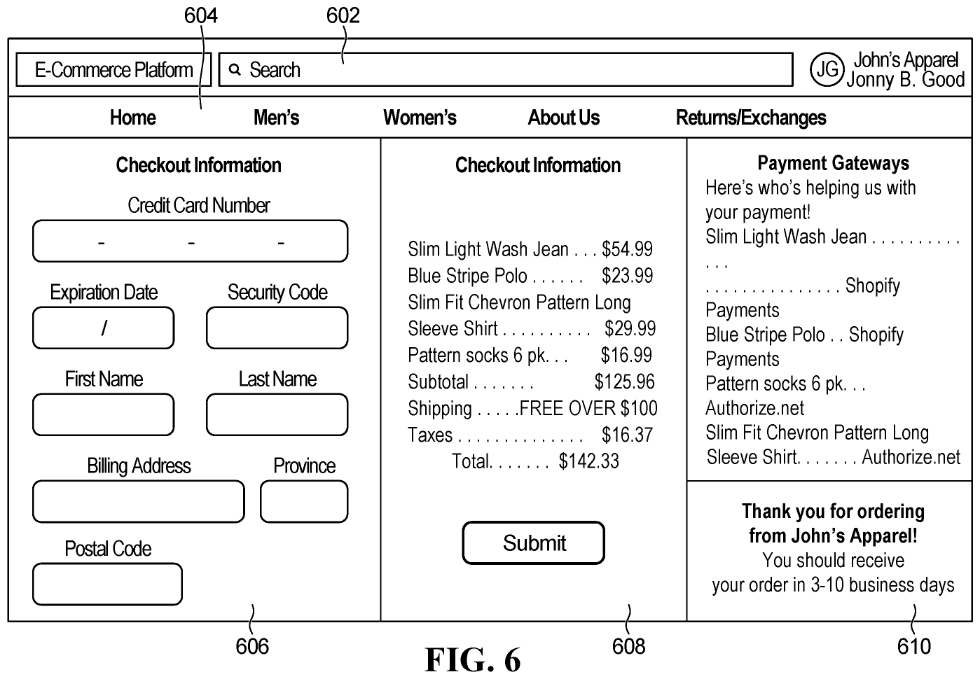

FIG. 6 illustrates an example of graphical user interface (henceforth referred to as a GUI) that may be used as a customer checkout interface, according to one implementation. The embodiment of FIG. 6 is suitable for use with approach described above, with reference to FIG. 4, in which the entire shopping cart is processed with a single transaction through a single selected payment gateway, and/or in a situation where multiple payment gateways may be used, but the payment gateway information is abstracted away from and obscured from the customer for the sake of convenience, speed, and simplicity of use. The customer merely has to submit their information and the rest is handled by the payment gateway(s).

### Payment Gateway Configuration Interface

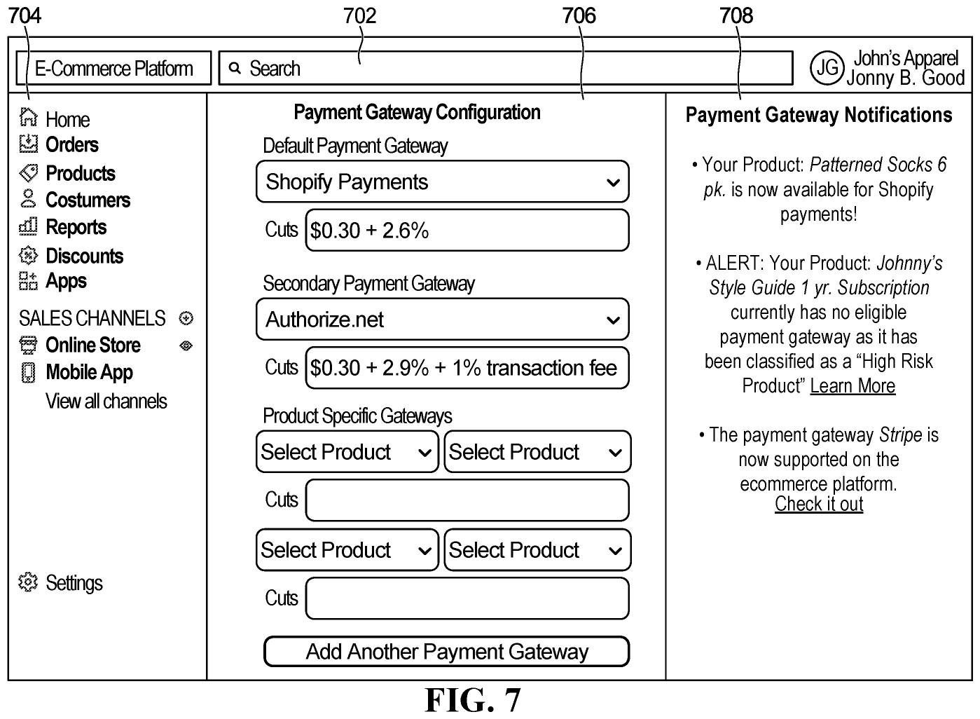

FIG. 7 illustrates an example of a GUI that may be used as a payment gateway configuration interface. This GUI may be implemented as part of an online store, app, or other interface. The GUI includes a search bar 702 which is capable of using keywords to locate information on the online store, app, or other interface which may include products, sales data, settings, or other information. A sidebar menu 704 is included in the GUI as a potential navigation tool to provide shortcuts to other pages (e.g. orders, product pages, financial information)

The GUI also includes payment gateway configuration fields 706 which are editable by the merchant. Each payment gateway has an associated cost, referred to as the “cut” that is specified in the payment gateway configuration field. The example is very simple, assuming a fixed cost plus a percentage. Other more complex costs for a given payment gateway are possible. Additionally, an “Add Another Payment Gateway” button is included so a merchant can add new gateways to the list of gateways available for use.

The payment gateway configuration fields 706 may be used by the merchant to determine which primary payment gateways they would like to use; they may also permit product specific customization which allows a merchant greater control over which payment gateways are used for which products. The fields may request one or more default payment gateway that is to be used in the absence of specific product settings. Payment gateways configuration fields 706 may be implemented in a variety of ways, such as drop-down menus, empty fields, and/or selection boxes. The display of a selected payment gateway may be accompanied with the associated costs of using said gateway, such as flat fees per transaction or percentages of purchases. The payment gateway configuration interface may also include a notification bar 708 which may list alerts, updates and information of interest to the merchant. Examples of potential notifications include new gateways available, products that have been made available for a specific gateway, updated product restrictions for gateways, and alerts for products being sold for which a payment gateway is unavailable or no longer supported.

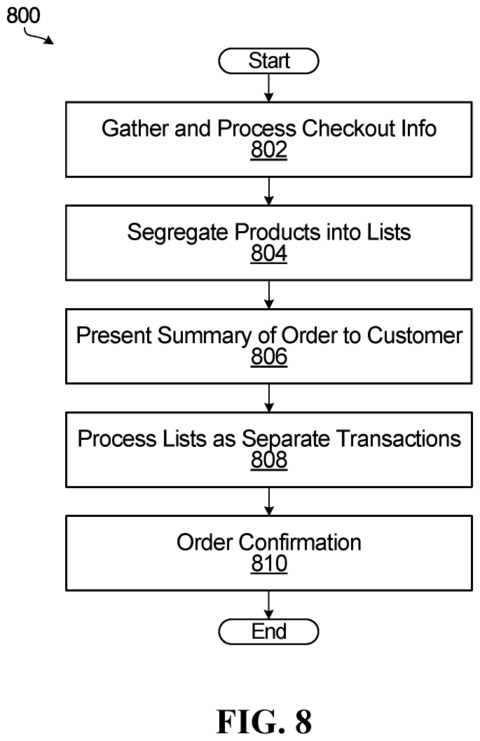

FIG. 8 illustrates a method performed by the system to complete a transaction with multiple payment gateways, according to a product specific implementation. At step 802, the product specific payment gateway selector 304 gathers and/or processes the checkout information 302 and identifies the products being checked out, the rules and preferences that govern said products, and the payment gateways at the disposal of the merchant. Examples of how the payment gateway(s) are selected have been provided previously and can be applied here.

At step 804, the product specific payment gateway selector 304 segregates the products of the order into lists of products for or assigns the products to payment gateways A-C 306A-C based on the preferred or optimal payment gateway for a specific product. At step 806, the assignments or lists of products for payment gateways A-C 306A-C may be sent and presented to the buyer (via a buyer device) in a format such as an order summary, or may be hidden from the customer (step omited). In some cases, additional fields may be provided for a user to fill out in order to use a certain gateway (e.g. Paypal). The buyer then commits to the order, and the transaction process is initiated.

At step 808, the order is split into the previously determined lists; each list of products for payment gateways A-C 306A-C order is processed by one of the corresponding payment gateways A-C 308A-C as a separate transaction until all lists have been processed. Each of the at least one of the payment gateways 308A-C performs the payment process described previously.

If any one of the transactions fails due to a flag for fraud, that transaction is halted, and may be rejected or removed from the buyer's order. In addition, the other transactions, even if they are initially successful, may be rejected as an added security measure.

At step 810, the system may generate and send a summary of the transaction, to the merchant (via a merchant device) with all sub-transactions listed in the order report. The system may also generate and send an order confirmation to the buyer (via a buyer device), which may or may not include these separate lists or the payment gateways used.

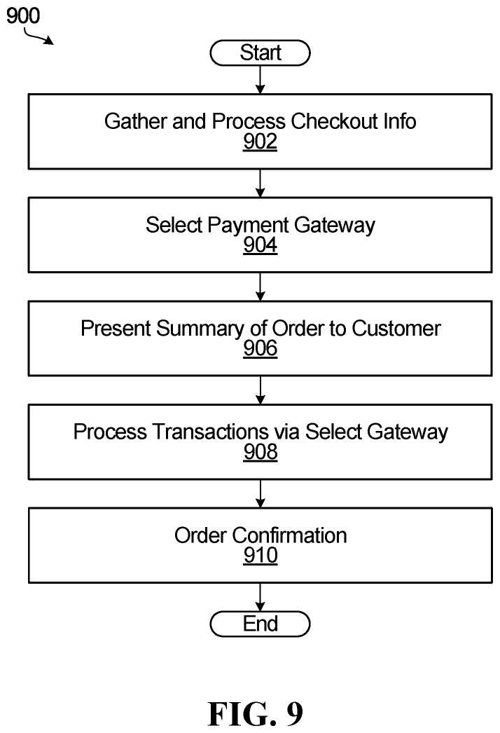

FIG. 9 illustrates a method performed by the system to complete a transaction with a selected payment gateway, according to a shopping cart specific implementation. At step 902, the shopping cart specific gateway selector 404 gathers and processes the checkout information 402; at step 904, it makes a determination of which gateway to use for the purchase. The products in the shopping cart may be evaluated for eligibility for each of the payment gateways A-C 406A-C. If the total order is such that only one gateway is available that may process all the items for the order (e.g. payment gateway C 406C) then the shopping card specific gateway selector 404 chooses to route the purchase through that gateway.

If more than one payment gateway is available to process the entire order, the shopping card specific gateway selector 404 may use additional factors to choose a gateway. For example, a weighted selection based on the products specifically configured by the merchant may be used. A default payment gateway may be chosen by the merchant to override the specific product configurations, or specific product configurations may override a default. Alternatively, the gateway that presents the lowest cost to the merchant may be chosen.

If none of the payment gateways A-C 406A-C is able to process one or more of the products in the order, the individual product may be rejected from the buyer's cart. The price of the item, along with any applicable incurred costs (i.e. taxes, shipping and handling) is subtracted from the order and the buyer is notified that the item cannot be processed. In another implementation, products that cannot be processed by any of the configured payment gateways A-C 406A-C are not visible to the buyer and cannot be added to a cart or order. Alternatively, the merchant must confirm that a product is supported by at least one of the payment gateways A-C 406A-C as a part of the process of adding the product to their catalogue.

In some embodiments, the payment gateway selection is also based on buyer information, such as creditworthiness of the buyer.

At step 906, the system may generate and send an order summary to the buyer (via a buyer device) that includes the payment gateway used, or this information may be hidden from the customer (step omited). In some cases, additional fields may be provided for a user to fill out in order to use a certain gateway (e.g. Paypal). The buyer then commits to the order (e.g. via selection of a buy or submit button), and the transaction process is initiated.

At step 908, the one of the payment gateways 406A-C that is chosen to process the transaction in the manner described previously. Note that if a fraud flag or some technical issue is detected, the order may be rejected.

At step 910, the merchant may receive (via a merchant device) a summary of the transaction, generated by the system, with the payment gateway chosen listed in the order report. The buyer may also receive an order confirmation (via a buyer device), which may or may not include the payment gateway used.

The description has focused on the embodiment in which the set of data is customer input selecting at least two products for purchase. In some such embodiments, data segregation is based at least in part on the products purchased. However, the more general embodiment of FIGS. 1A and 1B is not limited to this case. Multiple other use cases will now be described.

Segregate Pre-Tax Amount from Tax and Process Using Different Gateways

In another embodiment, the data segregator 62 segregates pre-tax amounts in respect of purchases from the tax payable. Then the transmitter transmits the data in respect of the pre-tax amounts on a first transmission channel to a first payment gateway, and transmits the data in respect of the tax payable on a second transmission channel to a second payment gateway. Optionally, the second payment gateway forwards the tax payments directly to the relevant tax authority. The second payment gateway would be selected based on the jurisdiction of where the tax is payable. This may, for example, be dependent on the address of the purchaser. Advantageously, different fee structures may be in place for the different payment gateways. For example, where the second payment gateway feeds payments directly to the relevant tax authority, a lower processing charge, possibly no processing charge, may be imposed.

In this case, the data segregation is not based on risk profile associated with the products. More generally, the segregation may be made based on a payment receipient or an ultimate destination for respective parts of a payment, for example, where some of the payment is due to a supplier, merchant, government etc. Again, different fee structures may be applied for the different payment gateways. In another example, the payment is split between a merchant and creator. For example, in the case of online content, the payment may be split between an online store providing the content and the creator of the content.

In another example, data segregation is used in the context of transactions where a tip can be specified. In this case, data in respect of the pre-tip amount is sent to a first payment gateway and data in respect of the tip is sent to a second payment gateway. For example, purchases made using the Starbucks™ app allow the customer to specify a tip. Data for the actual purchase can be the first payment gateway, and data for the tip sent to the second payment gateway. A similar approach can be applied to purchases on Uber™ app or Lyft™ app, for example.

In addition to providing the advantage of possibly different fee structures for the purchase amounts and the associated tax, this approach results in revenue being received by the relevant tax authorities sooner, and simplifies tax processing for the merchant.

Note that this embodiment can be combined with the product based embodiment, in which case, the data segregator segregates the pre-tax amounts between multiple payment gateways based on the products, and with all tax amounts going to another gateway designated for that purpose.

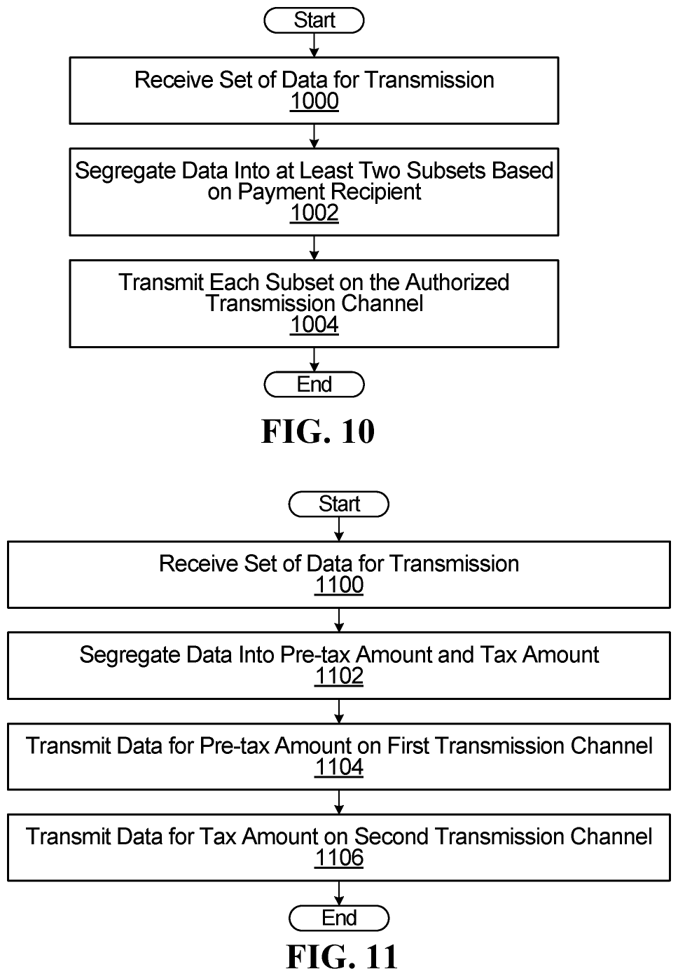

Referring now to FIG. 10, shown is a flowchart of a method where data is segregated based on payment recipient. The method begins in block 1000 with receiving a set of data for transmission. In some embodiments, receiving a set of data involves receiving customer input selecting at least two products for purchase. Detailed examples of receiving such customer input are provided above. The method continues with block 1002 with segregating the data into at least two subsets based on payment recipient (e.g. supplier, merchant, government, etc.). Each subset includes data in respect of payment to a respective payment recipient. The method continues in block 1004 with transmitting each subset on the authorized transmission channel for that subset. In some embodiments, transmitting each subset of data over the one of the plurality of transmission channels authorized for the subset comprises transmitting the subset to a respective payment gateway. The method can further involve determining a respective payment gateway for each payment recipient.

Referring now to FIG. 11, shown is a flowchart of a method where data is segregated based as between a pre-tax amount and a tax amount. The method begins in block 1100 with receiving a set of data for transmission. In some embodiments, receiving a set of data involves receiving customer input selecting at least two products for purchase. Detailed examples of receiving such customer input are provided above. The method continues with block 1102 with segregating the data into a subset of data in respect of pre-tax amount or values, and a subset of data in respect of a tax amount or values. The method continues with in block 1104 transmitting each subset on the authorized transmission channel for that subset. In some embodiments, transmitting each subset of data over the one of the plurality of transmission channels authorized for the subset comprises transmitting the subset to a respective payment gateway. The method may further involve determining a respective payment gateway for the subset associated with the pre-tax amount and for the subset associated with the tax amount.

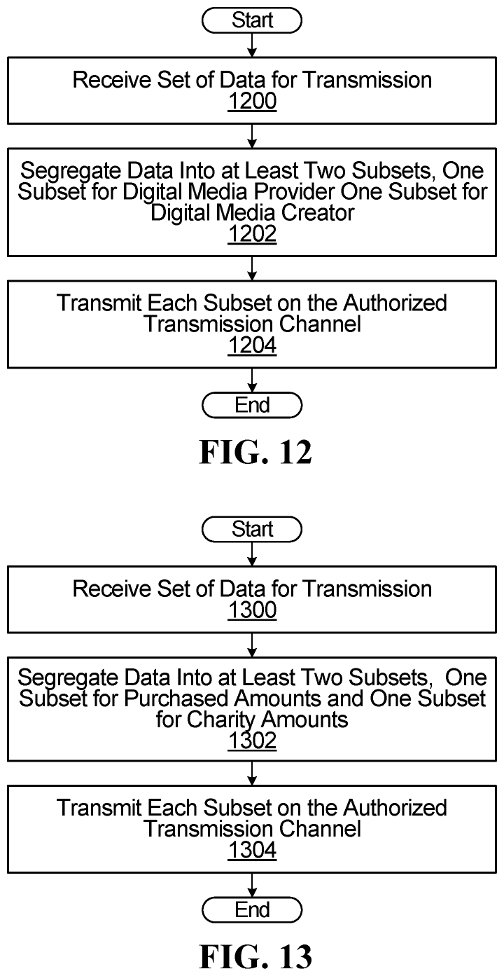

Referring now to FIG. 12, shown is a flowchart of a method where data is segregated based as between a digital media provider and a digital media creator. The method begins in block 1200 with receiving a set of data for transmission. In some embodiments, receiving a set of data involves receiving customer input selecting at least two products for purchase. Detailed examples of receiving such customer input are provided above. The method continues with block 1202 with segregating the data into a subset of data in respect of payment amounts to a digital media provider, and payment amounts (for example royalties) to a digital media creator or license holder. The method continues with in block 1204 transmitting each subset on the authorized transmission channel for that subset. In some embodiments, transmitting each subset of data over the one of the plurality of transmission channels authorized for the subset comprises transmitting the subset to a respective payment gateway. The method may further involve determining a respective payment gateway for the subset associated with payment to the digital media provider and for the subset associated with the payment to the digital media creator.

Segregate Amounts Associated with Product Purchase from Charity Amounts

In another embodiment, the data segregator 62 segregates amounts associated with product purchase from a charity amount. It has become common at checkout to provide the customer with the option of adding an amount for a charity. In this embodiment, the data associated with amounts in respect of the purchases is sent on a first transmission channel to a first payment gateway, and the data associated with the charity amount is transmitted on a second transmission channel to a second payment gateway.

In this embodiment, again, it is possible that different fee structures may be in place for the payment gateway used for the purchase amounts as opposed to the charity amount.

In addition to providing the advantage of possibly different fee structures for the purchase amounts and the charity amount, this approach results in revenue being received by the charity, and simplifies processing for the merchant.

Note that this embodiment can be combined with the product based embodiment and/or with the data segregation based on tax embodiment in which case, the data segregator segregates the pre-tax amounts between multiple payment gateways based on the products, a charity amount to another payment gateway designated for that purpose, and with all tax amounts going to another gateway designated for that purpose.

Referring now to FIG. 13, shown is a flowchart of a method where data is segregated based as between a purchase amount and a charity amount. The method begins in block 1300 with receiving a set of data for transmission. In some embodiments, receiving a set of data involves receiving customer input selecting at least two products for purchase. Detailed examples of receiving such customer input are provided above. The method continues with block 1302 with segregating the data into a subset of data in respect of purchase amounts or values, and a subset of data in respect of a charity amount or values. The method continues with in block 1304 transmitting each subset on the authorized transmission channel for that subset. In some embodiments, transmitting each subset of data over the one of the plurality of transmission channels authorized for the subset comprises transmitting the subset to a respective payment gateway. The method may further involve determining a respective payment gateway for the subset associated with the purchase amount and for the subset associated with the charity amount.

### Aggregate Multiple Transactions

In some embodiments, for any of the embodiments described herein, an additional data aggregation step takes place prior to transmission of data to capture payment. The data aggregation step combines the data from multiple transactions. For example, this might involve combining data for multiple digital music purchases from an online digital music provider. For some payment gateways, the transaction fees include a fixed base fee plus a percentage. As such, aggregating multiple transactions can result in reduced transaction fees. In some embodiments, in order to secure the funds for payment, an initial per-transaction authorization is performed. The authorization is maintained until such time as the payment is captured. For example, for the digital music case, an authorization is performed for each purchase by a customer, and at some time later a payment is captured that encompasses all of the purchases is closed, and the authorizations are released.

In some embodiments, amounts from the aggregate are paid out at different times via different payment gateways. For example, it might be appropriate for a sales agent to receive a commission earlier rather than waiting for the end of an aggregation cycle. In this case, one or more payments to an associated payment gateway, each in respect of the commission for one or more transactions, can take place before an aggregate transaction in respect of the balance to a different payment gateway.

Note the aggregation cycle, i.e. when the payment is captured, can be defined in various ways. For example, this can be based on:
a. Fixed time period—e.g. once a week;
b. When the total amount outstanding reaches a threshold amount;
c. When the customer chooses to pay.

This approach can be combined with any of the other embodiments described. For example, it can be combined with the embodiment in which payment is split to different recipients such as an online music merchant and a content creator. In this case, data in respect of a first aggregate amount is sent to a first payment gateway for payment to the online music merchant, and data in respect of a second aggregate amount is sent to a second payment for payment of an aggregate royalty to the creator.

In another example, this approach is combined with the approach that features data segregation used in the context of transactions where a tip can be specified. In this case, aggregate data in respect of the pre-tip amounts is sent to a first payment gateway and aggregate data in respect of the tips is sent to a second payment gateway. For the Starbucks™ app example detailed above, which allows the customer to specify a tip, data for multiple actual purchase can be aggregated and send to the first payment gateway, and data for the tip in respect of multiple purchase can be aggregated and sent to the second payment gateway.

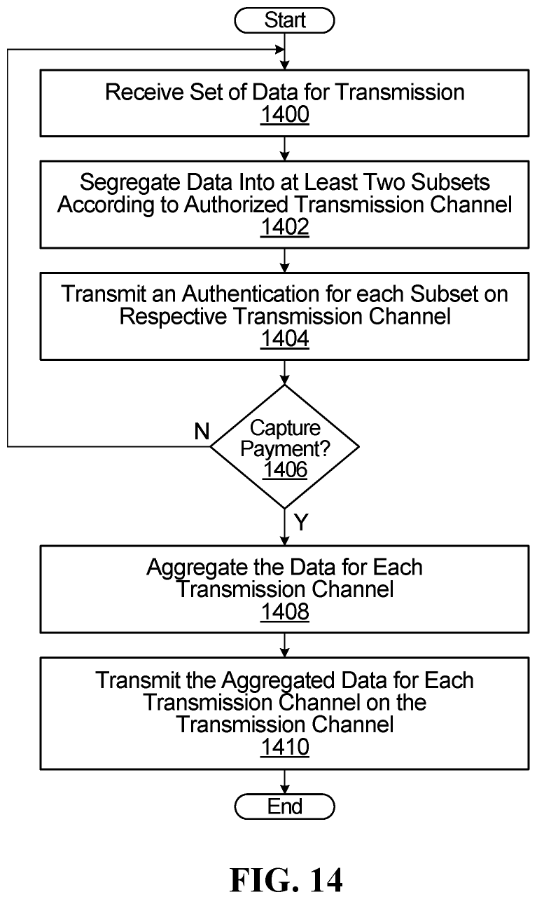

Referring now to FIG. 14, shown is a flowchart of a method where data aggregation is performed. The method begins in block 1400 with receiving a set of data for transmission. In some embodiments, receiving a set of data involves receiving customer input selecting at least two products for purchase. Detailed examples of receiving such customer input are provided above. The method continues with block 1402 with segregating the data into at least two subsets of data according to authorized transmission channels. Note this can be based on product, or based on payment recipient or both. The method continues in block 1404 with transmitting an authorization for each subset on the respective transmission channel. If it is not time to capture payment, no path block 1406, then the method continues back at block 1400 with the reception of further data for transmission. If it is time to capture payment, yes path block 1406, then the method continues in block 1408 with aggregating data for each transmission channel. For a given transmission channel, the subsets for that transmission channel that were segregated during one of the segregation steps are now aggregated into a set of aggregated data for that transmission channel. The method continues with in block 1410 transmitting each the aggregated data on each transmission channel.

Payment Gateway Selection Based on Buyer and/or Merchant Preferences

In some embodiments, the system is configured to receive an indication from a buyer and/or a merchant of a preferred payment gateway or gateways. These preferences can then be combined with other payment gateway selection criteria to reach a final decision of payment gateways (including where product based data segregation takes place, or other context described herein such as separation of tax, multiple destinations for payments etc.). In some embodiments, the buyer and/or the merchant can make preferred gateway selection for different use cases.

### Payment Gateway Selection Based on Jurisdiction

In some embodiments, jurisdiction is factored into payment gateway selection. For example, some products may be legal in one jurisdiction, and not legal in another jurisdiction. In some embodiments, payment gateway selection is configured to avoid selection of a payment gateway to process payment for a product that is illegal in one or more jurisdictions that the payment gateway operates. For example, if a product is legal for purchase in Canada, but not in the U.S., a payment gateway that operates in the U.S. and Canada can be disqualified on this basis. This additional constraint can be added to any of the other embodiments described herein.

Payment Gateways Vs. Payment Processors

The description has focussed on the transmission of data over transmission channels, mainly to different payment gateways. It is noted that for any embodiment described herein, there may also be a payment processor that interacts with customers, and is connected to multiple gateways. Payment processors may have their own fees.

Numerous modifications and variations of the present disclosure are possible in light of the above teachings. It is therefore to be understood that within the scope of the appended claims, the disclosure may be practiced otherwise than as specifically described herein.

1. An automated data transmission method comprising:
receiving a set of data for a data transmission;
segregating the set of data into at least two subsets of data according to which one of a plurality of available transmission channels is authorized to be used for each subset;
transmitting each subset of data over the one of the plurality of transmission channels authorized to be used for the subset.

2. The method of claim 1 wherein:
receiving a set of data comprises receiving customer input selecting at least two products for purchase;
segregating the set of data into at least two subsets comprises making a payment gateway decision by selecting at least two payment gateways from a plurality of available payment gateways to process the purchase of the at least two products, the payment gateway decision being made at least in part on the at least two products selected for purchase, such that each subset of data is associated with a respective selected payment gateway;
transmitting each subset of data over the one of the plurality of transmission channels authorized to be used for the subset comprises transmitting the subset to the respective payment gateway.

3. The method of claim 2 wherein transmitting checkout information to the selected at least one of the plurality of available payment gateways comprises:
for each of the available payment gateways, transmitting data on the products for which the available payment gateway was selected;

4. The method of claim 2 wherein:
receiving customer input selecting at least two products for purchase comprises receiving customer input selecting a plurality of products;
making the payment gateway decision comprises selecting a single payment gateway based on the plurality of products collectively.

5. The method of claim 2 further comprising:
configuring a checkout user interface to display the payment gateway decision to the customer.

6. The method of claim 2 wherein:
making the payment gateway decision is based on a risk associated with a given product.

7. The method of claim 2 wherein:
making the payment gateway decision is also based on customer information.

8. The method of claim 2 wherein:
making the payment gateway decision is based on the respective associated costs of use of the two or more available payment gateways.

9. The method of claim 2 wherein:
receiving configuration inputs to configure how the payment gateway decision is made.

10. The method of claim 2 further comprising:
providing a checkout user interface for receiving said customer input as a web page.

11. The method of claim 2 further comprising:
making the payment gateway decision is based on one or more configured preferences, said preferences being assigned as a product specific preference or as a default preference or a combination thereof.

12. The method of claim 1 wherein:
receiving a set of data comprises receiving customer input selecting at least two products for purchase; and
segregating the set of data into at least two subsets comprises segregating data into at least two subsets based on payment recipient, each subset including data in respect of payment to a respective payment recipient;
the method further comprising for each payment recipient, determining a respective payment gateway;
wherein transmitting each subset of data over the one of the plurality of transmission channels authorized to be used for the subset comprises transmitting the subset to the respective payment gateway.

13. The method of claim 1 wherein:
receiving a set of data comprises receiving customer input selecting at least two products for purchase; and
segregating the set of data into at least two subsets comprises segregating data into a subset associated with a pre-tax amount and a subset associated with a tax amount;
the method further comprising determining a respective payment gateway for the subset associated with the pre-tax amount and for the subset associated with the tax amount;
wherein transmitting each subset of data over the one of the plurality of transmission channels authorized to be used for the subset comprises transmitting the subset to the respective payment gateway.

14. The method of claim 1 wherein:
receiving a set of data comprises receiving customer input selecting at least two products for purchase; and
segregating the set of data into at least two subsets comprises segregating data into a subset associated a payment to a digital media provider and a subset associated with a payment amount to a digital media creator;
the method further comprising determining a respective payment gateway for the subset associated with payment to the digital media provider and for the subset associated with the payment to the digital media creator;
wherein transmitting each subset of data over the one of the plurality of transmission channels authorized to be used for the subset comprises transmitting the subset to the respective payment gateway.

15. The method of claim 1 wherein:
receiving a set of data comprises receiving customer input selecting at least two products for purchase; and
segregating the set of data into at least two subsets comprises segregating data into a subset associated with a purchase amount and a subset associated with a charity amount;
the method further comprising determining a respective payment gateway for the subset associated with the purchase amount and for the subset associated with the charity amount;
wherein transmitting each subset of data over the one of the plurality of transmission channels authorized to be used for the subset comprises transmitting the subset to the respective payment gateway.

16. The method of claim 2 further comprising:
aggregating data for multiple purchases before performing payment capture.

17. An automated data transmission apparatus comprising:
an interface for receiving a set of data for a data transmission;
a data segregator configured to segregating the set of data into at least two subsets of data according to which one of a plurality of available transmission channels is authorized to be used for each subset;
a transmitter configured to transmit each subset of data over the one of the plurality of transmission channels authorized to be used for the subset.

18. The apparatus of claim 17 wherein:
the interface for receiving a set of data comprises an interface for receiving customer input selecting at least two products for purchase;
the data segregator comprises a product specific payment gateway selector configured to make a payment gateway decision by selecting at least one payment gateway from a plurality of available payment gateways to process the purchase of the at least two products, the payment gateway decision being made at least in part on the at least two products selected for purchase, such that each subset of data is associated with a respective selected payment gateway;
the transmitter is configured to transmit each subset of data over the one of the plurality of transmission channels authorized to be used for the subset by sending the subset to the respective payment gateway.

19. The apparatus of claim 18 the product specific payment gateway selector is configured to transmit checkout information to the selected at least one of the plurality of available payment gateways by:
for each of the available payment gateways, transmitting data on the products for which the available payment gateway was selected.

20. The apparatus of claim 18 wherein the product specific payment gateway is configured to:
when the at least two products comprises a plurality of products, select a single payment gateway based on the plurality of products collectively.

21. The apparatus of claim 18 further configured to configure a checkout user interface to display the payment gateway decision to the customer.

22. The apparatus of claim 18 wherein the product specific payment gateway selector makes the payment gateway decision based on a risk associated with a given product.

23. The apparatus of claim 18 wherein the product specific payment gateway selector makes the payment gateway decision based on customer information.

24. The apparatus of claim 18 wherein the product specific payment gateway selector makes the payment gateway decision based on the respective associated costs of use of the two or more available payment gateways.

25. The apparatus of claim 18 further comprising:
a configuration interface for receiving configuration inputs to configure how the payment gateway decision is made.

26. The apparatus of claim 25 wherein the product specific gateway selector makes the payment gateway decision based on one or more configured preferences, said preferences being assigned as a product specific preference or as a default preference or a combination thereof.

27. An e-commerce platform comprising the apparatus of claim 18.
